(19) United States
(12) Patent Application Publication
(10) Pub. No.: US 2026/0152224 A1
(43) Pub. Date: Jun. 4, 2026

(54) STEERING AND SUSPENSION SYSTEM OF A VEHICLE

(71) Applicants: HYUNDAI MOTOR COMPANY, Seoul (KR); KIA CORPORATION, Seoul (KR)

(72) Inventors: Dong Hyun Kim, Hwaseong-si (KR); Jeong Chul Jung, Hwaseong-si (KR)

(73) Assignees: HYUNDAI MOTOR COMPANY, Seoul (KR); KIA CORPORATION, Seoul (KR)

(21) Appl. No.: 19/345,980

(22) Filed: Sep. 30, 2025

(30) Foreign Application Priority Data
Dec. 4, 2024 (KR) 10-2024-0178661

(51) Int. Cl. B62D 5/04; B60G 3/10; B60K 7/00

(52) U.S. Cl. CPC B62D 5/0418; B60G 3/10; B60K 7/0007; B62D 5/0421; B60K 2007/0092

(57) ABSTRACT

A steering and suspension system for steering a wheel for a vehicle may include: a rubber torsion suspension connecting the wheel and a vehicle body and configured to alleviate shock transferred from a road surface to the vehicle body through the wheel, a bevel gear provided in an upper portion of the rubber torsion suspension and configured to axially rotate and turn together with the rubber torsion suspension when the vehicle turns, and a gear rotation guide engaged with the bevel gear and configured to guide a moving path of the bevel gear and the rubber torsion suspension when the bevel gear axially rotates and turns.

### CROSS-REFERENCE TO RELATED APPLICATION

This application claims priority to and the benefit of Korean Patent Application No. 10-2024-0178661 filed with the Korean Intellectual Property Office on Dec. 4, 2024, the entire contents of which is incorporated herein by reference.

### FIELD

The present disclosure relates to a steering and suspension system of a vehicle.

### BACKGROUND

The statements in this section merely provide background information related to the present disclosure and may not constitute prior art.

Recently, future mobility visions with new concepts for implementing human-oriented dynamic future cities have been introduced in vehicle industries. One of the future mobility solutions is a purpose-built vehicle (PBV) as a purpose-based mobility vehicle.

Examples of the PBV may include an environmentally-friendly movable vehicle based on an electric vehicle (EV). The PBVs may provide various customized services to users while the PBVs move from starting points to destinations in an unmanned or manned autonomous driving manner.

The PBV may include a cab-type drive module equipped with a drive device and capable of autonomously traveling, and a space module coupled to the drive module and configured to be used for cargo, passengers, home office, or the like.

The drive module and the space module may each include an under body, and an upper body coupled to an upper portion of the under body and configured to be movable together with the under body by driving power from the under body.

For PBV vehicles, it is important to implement a platform that is as compact and flat as possible to secure maximum variable upper body space. However, suspensions commonly used in current passenger cars, such as the MacPherson strut suspension, have difficulty forming a low and flat top surface due to their structural characteristics.

On the other hand, suspensions applied to non-driven wheels, such as rubber torsion axles, have a compact and simple structure, but have a problem in that they cannot be steered and can only be applied to non-driven axles.

### SUMMARY

The present disclosure provides a steering and suspension system of a vehicle capable of securing a vehicle body space to improve convenience and providing a compact integrated module, by employing a rubber torsion type suspension disposed in a lower floor portion of a vehicle body, configured to alleviate shocks transferred to the vehicle body, and providing a steering function.

In an embodiment of the present disclosure, a steering and suspension system of a vehicle, configured to steer a wheel of the vehicle, may include a rubber torsion suspension that connects the wheel and a vehicle body. The rubber torsion suspension is configured to alleviate shock transferred from a road surface to the vehicle body through the wheel. The steering and suspension system further includes: a bevel gear disposed above a tope portion of the rubber torsion suspension and configured to rotate about an axis of the bevel gear and to turn together with the rubber torsion suspension when the vehicle turns. The steering and suspension system further includes a gear rotation guide engaged with the bevel gear and configured to guide a moving path of the bevel gear and the rubber torsion suspension when the bevel gear axially rotates and turns.

The bevel gear may be spaced apart, forming an interval, from an upper surface of the rubber torsion suspension in a height direction of the vehicle.

The bevel gear may have a radius that gradually decreases from an inner side of the vehicle body toward the wheel.

The gear rotation guide may have convex shape curving toward the inner side of the vehicle body.

The rubber torsion suspension may be located further toward a center of the vehicle body than an axis of the wheel in a length direction of the vehicle, and the bevel gear may be disposed so that the axis of the bevel gear is on the same axis as the axis of the wheel, on the upper surface of the rubber torsion suspension.

The gear rotation guide is provided to cover the bevel gear, to be in contact and engaged with and to rotate with the bevel gear in a lower portion of the bevel gear, and to be spaced apart from the bevel gear in an upper portion of the bevel gear.

An upper outer surface of the gear rotation guide, which covers the upper portion of the bevel gear, may be fixed to the vehicle body.

The wheel may be steered by a gear box directly connected to a drive shaft configured to drive the wheel.

The wheel may be steered by driving a steering motor directly connected to the bevel gear.

A rotation shaft of a steering motor may be directly connected to a rotation axis of the bevel gear, and the bevel gear may be axially rotated when driving the steering motor.

The wheel may be driven by an in-wheel motor including a rotor connected to an axis of the wheel and a stator configured to rotate the rotor by application of current.

A rotor disc brake configured to decrease or stop a rotation of the wheel may be provided on a central axis of the in-wheel motor.

A steering and suspension system for steering a wheel of a mobility vehicle may include: a bevel gear connecting the wheel and a vehicle body and configured to axially rotate about its rotation axis and to turn when the mobility vehicle turns; and a gear rotation guide engaged with the bevel gear and configured to guide a moving path of the bevel gear as the bevel gear moves while axially rotating.

The steering and suspension system further includes a rubber torsion suspension configured to alleviate shock transferred from a road surface to the vehicle body through the wheel, wherein the bevel gear is disposed to be spaced apart from the rubber torsion suspension in a height direction of the mobility vehicle.

The rubber torsion suspension is located further toward a center of the vehicle body than an axis of the wheel in a length direction of the mobility vehicle, and the bevel gear is disposed above a top surface of the rubber torsion suspension and the rotation axis of the bevel gear is on the same axis as the axis of the wheel.

According to an embodiment, a flat underbody structure and platform may be implemented by integrating a suspension system formed in a rubber torsion suspension and a steering system formed of a bevel gear.

In addition, by forming a low and flat upper surface, a vehicle body space above the steering and suspension system can be secured, so that the loading floor height is lowered to enhance the user's convenience and increase the usability of the loading space is increased, thereby providing utility for various purposed mobility.

In addition, by adding a drive system and braking system to the steering and suspension system, a compact integrated module may be configured. This integrated system may also be applied to a mobility vehicle. The mobility vehicle refers to compact, often electric or autonomous vehicles designed for short-range transport, accessibility, or urban mobility solutions.

### BRIEF DESCRIPTION OF THE DRAWINGS

FIG. 1 is a perspective view illustrating a steering and suspension system of a vehicle according to an embodiment.

FIG. 2 is a front view illustrating a steering and suspension system of a vehicle of FIG. 1.

FIG. 3 is a top view illustrating a steering process of a steering and suspension system of a vehicle of FIG. 1.

FIG. 4 is a perspective view illustrating, according to an embodiment, an example of steering a steering and suspension system of a vehicle using a gear box.

FIG. 5 is a rear view illustrating a steering and suspension system of a vehicle of FIG. 4.

FIG. 6 is a top view illustrating a steering and suspension system of a vehicle of FIG. 4.

FIG. 7 is a perspective view illustrating, according to an embodiment, an example of steering a steering and suspension system of a vehicle using steering motor.

FIG. 8 is a rear view illustrating a steering and suspension system of a vehicle of FIG. 7.

FIG. 9 is a top view illustrating a steering and suspension system of a vehicle of FIG. 7.

FIG. 10 is a perspective view illustrating an example of steering a steering and suspension system of a vehicle by a gear box, to which an in-wheel motor and a disc brake are added.

FIG. 11 is a rear view illustrating a steering and suspension system of a vehicle of FIG. 10.

FIG. 12 is a top view illustrating a steering and suspension system of a vehicle of FIG. 10.

FIGS. 13A and 13B are side views respectively illustrating a steering and suspension system of a vehicle of FIG. 10.

FIG. 14 is a perspective view illustrating an example of steering a steering and suspension system of a vehicle using a steering motor according to an embodiment, to which an in-wheel motor and a disc brake are added.

FIG. 15 is a rear view illustrating a steering and suspension system of a vehicle of FIG. 14.

FIG. 16 is a top view illustrating a steering and suspension system of a vehicle of FIG. 14.

FIGS. 17A and 17B are side views respectively illustrating a steering and suspension system of a vehicle of FIG. 14.

### DETAILED DESCRIPTION

The present disclosure is described more fully hereinafter with reference to the accompanying drawings, in which certain embodiments of the disclosure are illustrated. As those having ordinary skill in the art would realize, the described embodiments may be modified in various different ways, all without departing from the spirit or scope of the present disclosure.

In various embodiments, the same reference numerals are used for elements having the same configurations. These elements are representatively described in a first embodiment, and in other embodiments, only elements that differ from those of the first embodiment are described.

The drawings are schematic, and are not illustrated in accordance with a scale. Relative dimensions and ratios of portions in the drawings are illustrated to be exaggerated or reduced in size for clarity and convenience, and the dimensions are just examples and are not limiting. In addition, like structures, elements, or components illustrated in two or more drawings use same reference numerals for showing similar features. It should be understood that when an element such as a layer, film, region, or substrate is referred to as being “on” another element, it can be directly on the other element or intervening elements may also be present.

When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, apparatus, and the like may separately embody or be included with a processor and a memory, such as a non-transitory computer readable media, as part of the apparatus.

The embodiment of the present disclosure shows an embodiment of the present disclosure in detail. As a result, various modifications of the drawings will be expected. Therefore, the embodiments are not limited to a specific shape of an illustrated region, but, for example, include a change in the shape in accordance with manufacturing.

Hereinafter, a steering and suspension system of a vehicle structure according to an embodiment is described in detail with reference to the drawings.

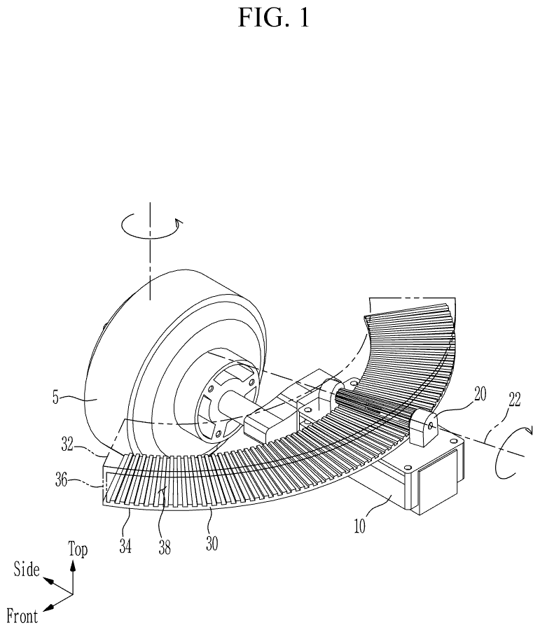

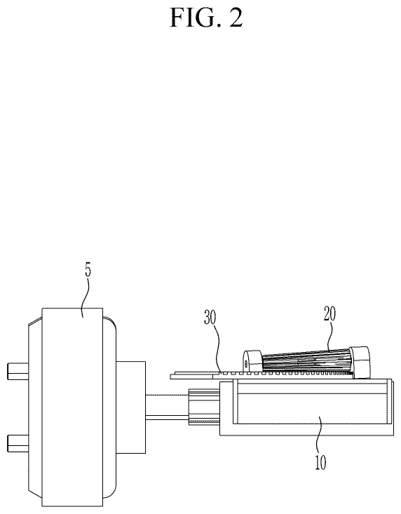

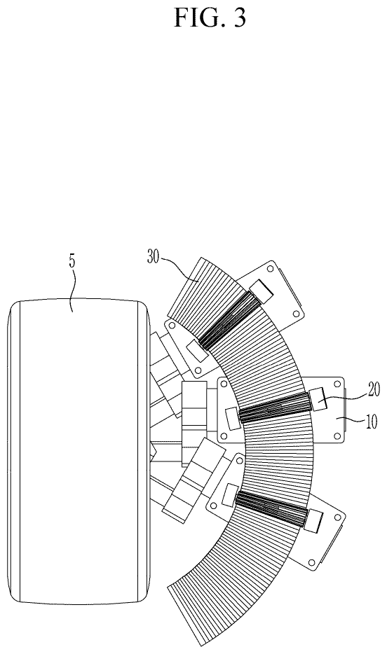

FIG. 1 is a perspective view showing a steering and suspension system of a vehicle according to an embodiment, FIG. 2 is a drawing showing a steering and suspension system of a vehicle of FIG. 1 when viewed from the front, and FIG. 3 is a drawing showing a steering process of a steering and suspension system of a vehicle of FIG. 1 when viewed from the top.

Referring to FIG. 1 to FIG. 3, a steering and suspension system of a vehicle, according to an embodiment, may be disposed in a floor lower portion of the vehicle body, and the a steering and suspension system may be configured to alleviate the shock transferred from the outside to the vehicle body and at the same time, steer a wheel 5 provided in the vehicle body.

A steering and suspension system of a vehicle according to an embodiment may include a rubber torsion suspension 10, a bevel gear 20, and a gear rotation guide 30.

The rubber torsion suspension 10 may have a structure in which rubber is provided inside and a plate surrounds the rubber, and since the rubber inside absorbs vibrations caused by torsion or the like transmitted from the vehicle, vibrations can be minimized and shock absorption can be improved. This may minimize the vibration when the vehicle corners or turns, and may improve the ride comfort and steering characteristics.

The rubber torsion suspension 10 may connect the wheel 5 and the vehicle body, to alleviate shock and vibration transferred from a road surface to the vehicle body through the wheel 5.

The bevel gear 20 may be provided above an upper portion or a top portion of the rubber torsion suspension 10, and may be moved together when the rubber torsion suspension 10 moves. In other words, when the wheel 5 turns in a horizontal direction of the vehicle body, the bevel gear 20 may turn together with the rubber torsion suspension 10. In addition, the bevel gear 20 may be configured to axially rotate at the upper portion of the rubber torsion suspension 10. In other words, the bevel gear 20 may be configured to rotate about its axis 22 while positioned at the upper portion of the rubber torsion suspension 10. The bevel gear 20 may turn together with the rubber torsion suspension 10 and also perform axial rotation simultaneously.

As shown in FIG. 2, the bevel gear 20 is a type of crossed-axis gears and may be formed in an approximately conical shape, with a radius that gradually decreases from an inner side of the vehicle body toward the wheel 5.

The bevel gear 20 may be disposed to be space apart from the top portion or an upper surface of the rubber torsion suspension 10 in a height direction of the vehicle. Both ends of the bevel gear 20 may be coupled to a supporting member formed on and protrude from the upper surface of the rubber torsion suspension to be able to axially rotate.

The gear rotation guide 30 may be engaged with the bevel gear 20 and guide the moving path of the rubber torsion suspension 10 and the bevel gear 20 when the bevel gear axially rotates and turns.

The gear rotation guide 30 may be located in the upper portion of the rubber torsion suspension 10 and may have a convex shape curving toward the inner side of the vehicle body. The gear rotation guide 30 may be formed in the form of an imaginary fan-shaped arc portion having a predetermined curvature, and may be formed so that the center of the imaginary fan-shape coincide with the central point of the wheel 5. In addition, an axis 22 of the bevel gear 20 may be disposed to be perpendicular to a path of the gear rotation guide 30. Therefore, when the wheel 5 turns, the axis 22 of the bevel gear 20 may continuously maintain a direction toward a center of the wheel 5.

The gear rotation guide 30 may be provided to cover the bevel gear 20. The gear rotation guide 30 may have an upper surface 32, a lower surface 34, and a side surface 36, where an end portion 38 of the arc portion is open. The bevel gear 20 may move along a length direction of the arc portion in an interior of the gear rotation guide 30.

A lower portion of the bevel gear 20 may rotate and move while being in contact with the lower surface 34 of the gear rotation guide 30 and engaged with gear teeth formed on the lower surface of the gear rotation guide 30, and an upper portion of the bevel gear 20 is spaced apart from the upper surface 32 of the gear rotation guide 30 by a predetermined interval. That is, the lower surface of the gear rotation guide 30 may be disposed between the bevel gear 20 and the rubber torsion suspension 10.

In an embodiment, a movement range of the bevel gear 20 may be limited by a length of the gear rotation guide 30, and an outer surface of the upper surface of the gear rotation guide 30 may be fixed to the vehicle body.

The rubber torsion suspension 10 may be located further toward, closer to, a center of the vehicle body than an axis of the wheel 5 in the length direction (i.e., longitudinal direction) of the vehicle, and the bevel gear 20 may be disposed so that the axis of the bevel gear 20 is on the same axis as, or aligns with, the axis of the wheel 5, and is positioned on the upper surface of the rubber torsion suspension 10. In other words, as shown in FIG. 3, the rubber torsion suspension 10 may be disposed at a rear side of the vehicle based on an axis of the front wheel 5, and the bevel gear 20 may be disposed above the upper portion of the rubber torsion suspension 10, oriented obliquely toward the center of the wheel 5.

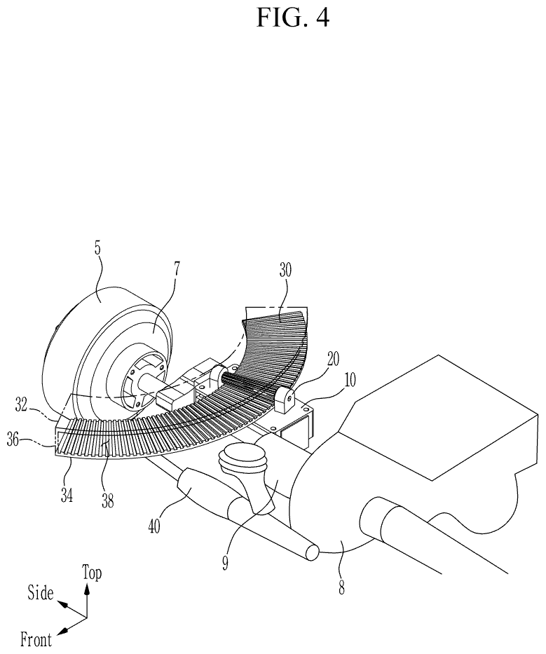

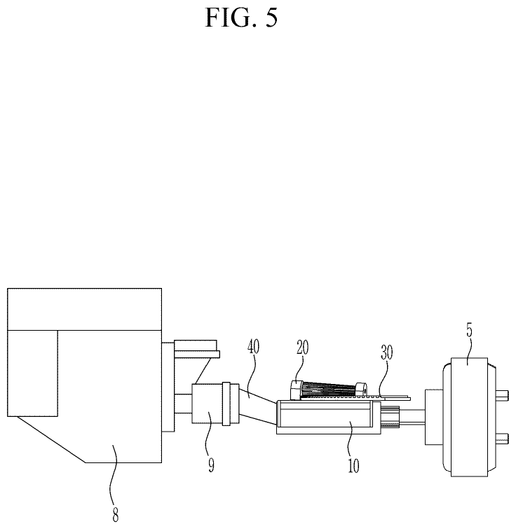

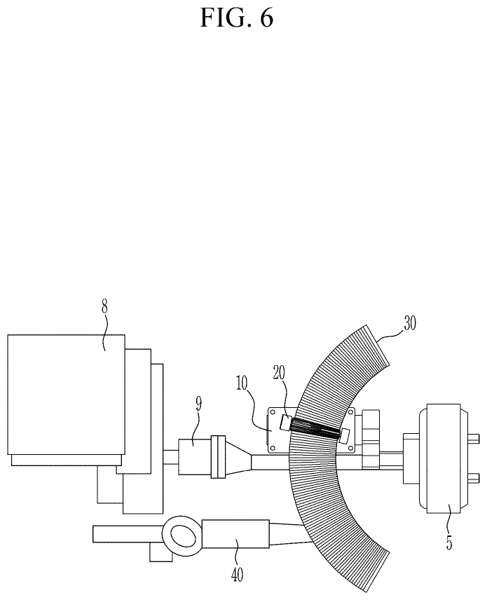

FIG. 4 is a perspective view showing an example of steering by a gear box of a steering and suspension system of a vehicle according to an embodiment, and FIG. 5 is a drawing showing a steering and suspension system of a vehicle of FIG. 4 when viewed from the rear, and FIG. 6 is a drawing showing a steering and suspension system of a vehicle of FIG. 4 when viewed from the top.

Referring to FIG. 4 to FIG. 6, the wheel 5 may be steered by a gear box 40 directly connected to a drive shaft 9 configured to drive the wheel 5.

The gear box 40 is an apparatus for transferring the power required for rotating the axis of the wheel 5, and may be configured in a box as various gears. The gear box 40 may convert a torque to another speed through the gears, or may adjust the torque together with the rotation speed. In addition, it may serve to change the rotating direction by changing the arrangement of gears.

According to an embodiment, when a force is applied to the wheel 5 through a tie-rod provided in the gear box 40, the wheel 5 may turn about a central axis. At this time, the rubber torsion suspension 10 connected to the wheel 5 may also turn together. As the rubber torsion suspension 10 turns, the bevel gear 20 fixed to the rubber torsion suspension 10 may turn along the gear rotation guide 30.

At this time, since the wheel 5 is steered by the gear box 40, the bevel gear 20 is not directly responsible for steering, but may serve to guide and stably support a turning direction of the wheel 5 while turning along the gear rotation guide 30.

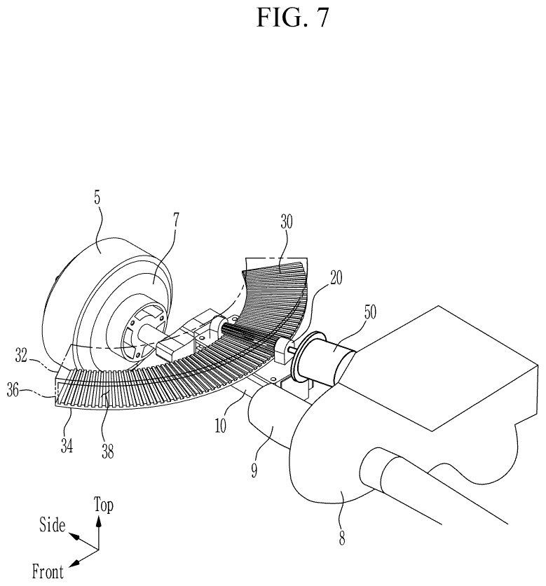

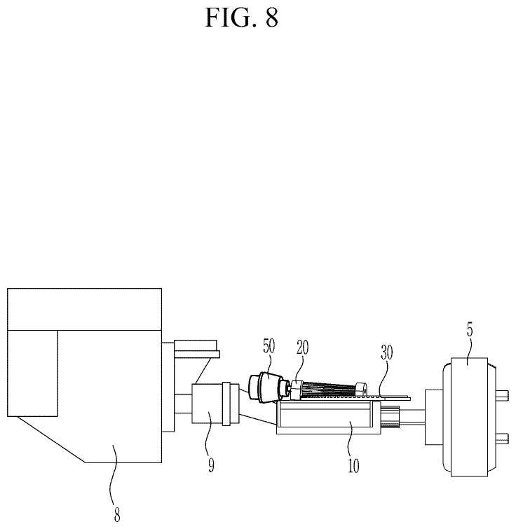

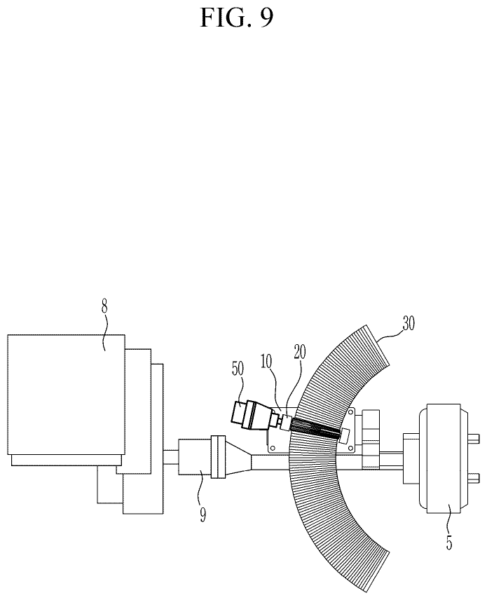

FIG. 7 is a perspective view showing an example of steering by a steering motor of a steering and suspension system of a vehicle according to an embodiment, FIG. 8 is a drawing showing a steering and suspension system of a vehicle of FIG. 7 when viewed from the rear, and FIG. 9 is a drawing showing a steering and suspension system of a vehicle of FIG. 7 when viewed from the top.

Referring to FIG. 7 to FIG. 9, the wheel 5 may be steered by driving a steering motor 50 directly connected to the bevel gear 20.

The steering motor 50 is a component for controlling the steering of the vehicle by using an electronic system without involving a mechanical and hydraulic connection by a steer-by-wire method. When the electronic control unit (ECU) transmits a steering angle signal to the motor control unit (MCU), the steering motor 50 may be rotated based on the signal received by the motor control unit.

An axis of the steering motor 50 may be connected to the axis of the bevel gear 20, and rotation of the steering motor 50 may cause the bevel gear 20 to rotate. When the bevel gear 20 rotates, the bevel gear 20 may turn along the gear rotation guide 30, and the rubber torsion suspension 10 connected to the bevel gear 20 may also turn.

Since the rubber torsion suspension 10 is connected to the axis of the wheel 5, as the rubber torsion suspension 10 turns, the wheel 5 may turn.

In an example of steering by the steering motor 50 according to the present embodiment, since the mechanical component part and the hydraulic pressure system are not required, the vehicle interior space may be saved, the degree of design freedom may be improved, and the weight of the vehicle may be decreased, thereby improving the fuel efficiency.

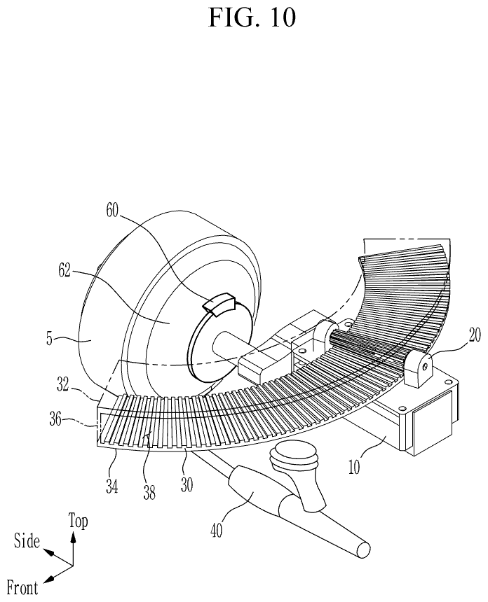

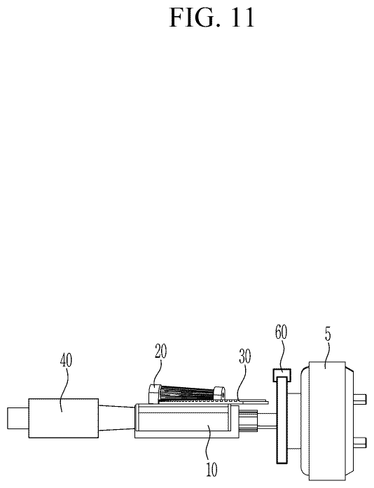

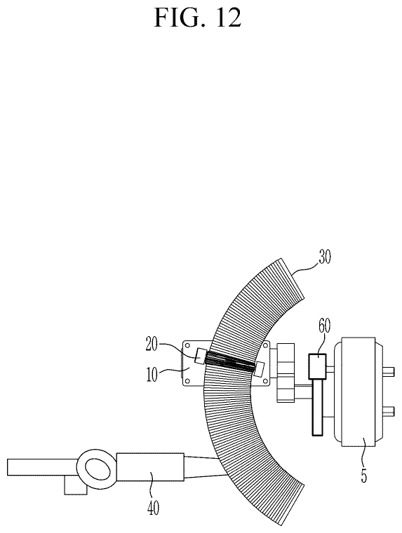

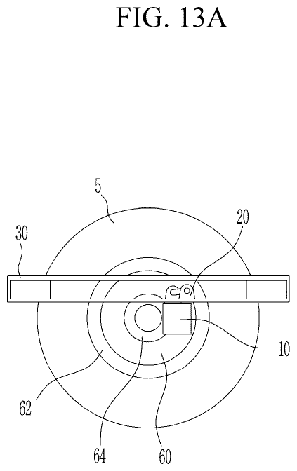

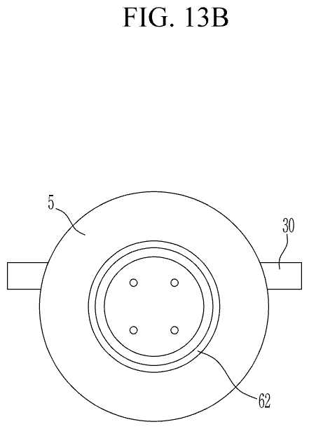

FIG. 10 is a perspective view showing an example of steering a steering and suspension system of a vehicle according to an embodiment by gear box, to which an in-wheel motor and a disc brake are added, FIG. 11 is a drawing showing a steering and suspension system of a vehicle of FIG. 10 when viewed from the rear, FIG. 12 is a drawing showing a steering and suspension system of a vehicle of FIG. 10 when viewed from the top, and FIGS. 13A and 13B are views showing a steering and suspension system of a vehicle of FIG. 10 when viewed from the lateral side.

Referring to FIG. 10 to FIGS. 13A-13B, the wheel 5 may be steered by the gear box 40 directly connected to the drive shaft 9 configured to drive the wheel 5. When a force is applied to the wheel 5 through a tie-rod provided in the gear box 40, the wheel 5 may turn about a central axis, and the rubber torsion suspension 10 connected to the wheel 5 may also turn together. As the rubber torsion suspension 10 turns, the bevel gear 20 fixed to the rubber torsion suspension 10 may turn along the gear rotation guide 30.

Meanwhile, the wheel 5 may be driven by an in-wheel motor 62. The in-wheel motor 62 may include a rotor 64 connected to the axis of the wheel 5, and a stator configured to rotate the rotor by application of current.

The in-wheel motor 62 may be an electric vehicle drive system in which an electric motor is directly mounted on each wheel 5 to drive the wheel 5. Unlike a drive method using a traditional internal combustion engine and a transmission, efficient energy transfer is possible because the wheel 5 and the motor are directly connected.

The rotor 64 may be connected an interior of to the wheel 5 to rotate with the wheel 5. The rotor in the in-wheel motor 62 is a portion that rotates by receiving electricity. The stator may be fixed to the vehicle, and rotate the rotor 40 by applying a current. The stator is a fixed portion of the in-wheel motor 62, and may be typically formed of a coil or a magnet. When the electrical energy passes through the stator, a magnetic field may be generated, and this magnetic field can rotate the rotor.

A rotor disc brake 60 configured to decrease or stop the rotation of the wheel 5 may be provided on a central axis of the in-wheel motor 62. The rotor disc brake 60 may be provided on a central axis of the rotor, and a caliper may be provided on the stator to brake the vehicle by applying a frictional force to the rotor by being in contact with the rotor disc brake 60.

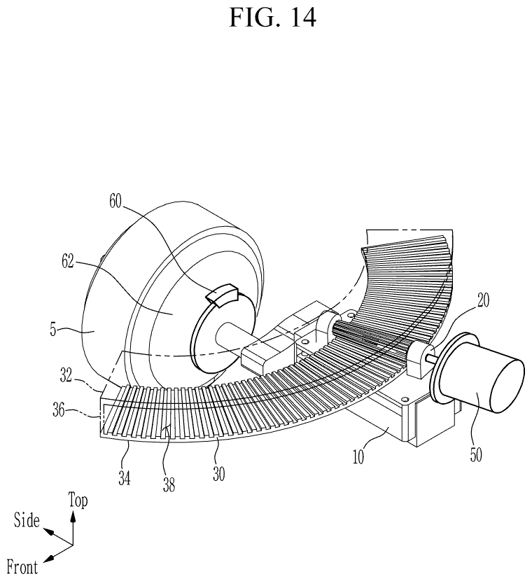

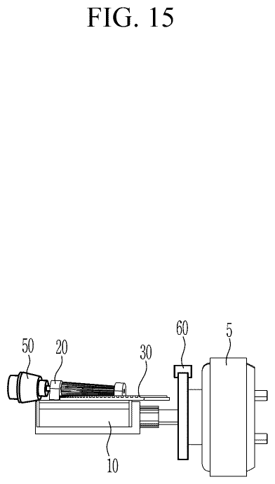

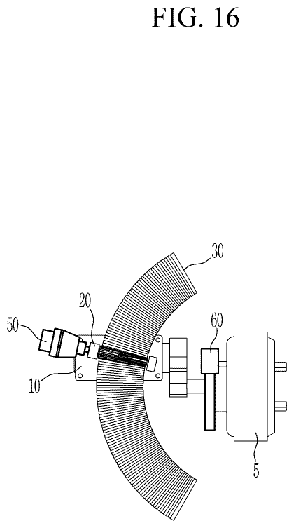

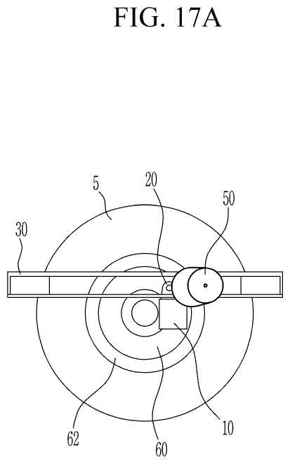

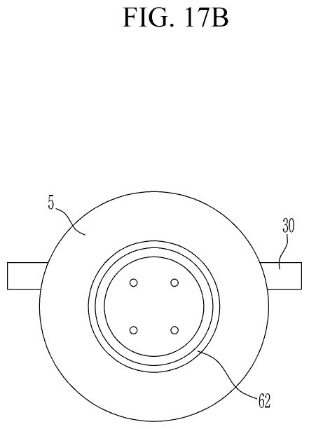

FIG. 14 is a perspective view showing an example of steering a steering and suspension system of a vehicle according to an embodiment by steering motor, to which an in-wheel motor and a disc brake are added, FIG. 15 is a drawing showing a steering and suspension system of a vehicle of FIG. 14 when viewed from the rear, FIG. 16 is a drawing showing a steering and suspension system of a vehicle of FIG. 14 when viewed from the top, and FIGS. 17A-17B are views showing a steering and suspension system of a vehicle of FIG. 14 when viewed from the lateral side.

Referring to FIG. 14 to FIGS. 17A-17B, the wheel 5 may be steered by driving the steering motor 50 directly connected to the bevel gear 20.

The axis of the steering motor 50 may be connected to the axis of the bevel gear 20, and the rotation of the steering motor 50 may rotate the bevel gear 20. When the bevel gear 20 rotates, the bevel gear 20 may turn along the gear rotation guide 30, and the rubber torsion suspension 10 connected to the bevel gear 20 may also turn. Since the rubber torsion suspension 10 is connected to the axis of the wheel 5, as the rubber torsion suspension 10 turns, the wheel 5 may turn.

The wheel 5 may be driven by the in-wheel motor 62 comprised of the rotor connected to the axis of the wheel 5 and the stator configured to rotate the rotor by application of current, and the braking of the vehicle may be achieved by the rotor disc brake 60 provided on the central axis of the rotor and the caliper provided on the stator to be in contact with the rotor disc brake 60.

As such, according to an embodiment, a flat underbody structure and platform may be implemented by integrating a suspension system formed in a rubber torsion suspension and a steering system formed of a bevel gear.

In addition, by forming a low and flat upper surface, a vehicle body space above the steering and suspension system can be secured, so that the loading floor height is lowered to enhance the user's convenience and increase the usability of the loading space is increased, thereby providing utility for various purposed mobility.

In addition, by adding a drive system and braking system to the steering and suspension system, a compact integrated module may be configured.

While this disclosure has been described in connection with what is presently considered to be practical exemplary embodiments, it is to be understood that the disclosure is not limited to the disclosed embodiments. On the contrary, it is intended to cover various modifications and equivalent arrangements included within the spirit and scope of appended claims.

### Description of Symbols

5: wheel
9: drive shaft
10: rubber torsion suspension
20: bevel gear
30: gear rotation guide
40: gear box
50: steering motor
60: rotor disc brake
62: in-wheel motor

What is claimed is:

1. A steering and suspension system for steering a wheel of a vehicle, the steering and suspension system of a vehicle comprising:
a rubber torsion suspension configured to connect the wheel to a vehicle body and to alleviate shock transferred from a road surface to the vehicle body through the wheel;
a bevel gear disposed above a top portion of the rubber torsion suspension and configured to rotate about an axis thereof and turn together with the rubber torsion suspension when the vehicle turns; and
a gear rotation guide engaged with the bevel gear and configured to guide a moving path of the bevel gear and the rubber torsion suspension when the bevel gear axially rotates and turns.

2. The steering and suspension system of a vehicle of claim 1, wherein the bevel gear is spaced apart from an upper surface of the rubber torsion suspension in a height direction of the vehicle.

3. The steering and suspension system of a vehicle of claim 2, wherein the bevel gear has a radius that gradually decreases from an inner side of the vehicle body toward the wheel.

4. The steering and suspension system of a vehicle of claim 3, wherein the gear rotation guide has a convex shape curving toward the inner side of the vehicle body.

5. The steering and suspension system of a vehicle of claim 4, wherein:
the rubber torsion suspension is located further toward a center of the vehicle body than an axis of the wheel in a length direction of the vehicle; and
the bevel gear is disposed so that the axis of the bevel gear is on the same axis as the axis of the wheel, on the upper surface of the rubber torsion suspension.

6. The steering and suspension system of a vehicle of claim 4, wherein the gear rotation guide is configured to:
cover the bevel gear;
be engaged with and rotate with the bevel gear in a lower portion of the bevel gear; and
be spaced apart from the bevel gear in an upper portion of the bevel gear.

7. The steering and suspension system of a vehicle of claim 6, wherein an upper outer surface of the gear rotation guide, which covers the upper portion of the bevel gear, is fixed to the vehicle body.

8. The steering and suspension system of a vehicle of claim 1, wherein the wheel is steered by a gear box directly connected to a drive shaft configured to drive the wheel.

9. The steering and suspension system of a vehicle of claim 1, wherein the wheel is steered by driving a steering motor directly connected to the bevel gear.

10. The steering and suspension system of a vehicle of claim 8, wherein:
a rotation shaft of a steering motor is directly connected to the axis of the bevel gear; and
the bevel gear is axially rotated when driving the steering motor.

11. The steering and suspension system of a vehicle of claim 1, wherein the wheel is driven by an in-wheel motor comprising a rotor connected to an axis of the wheel and a stator configured to rotate the rotor.

12. The steering and suspension system of a vehicle of claim 11, wherein a rotor disc brake configured to decrease or stop a rotation of the wheel is provided on a central axis of the in-wheel motor.

13. A steering and suspension system for steering a wheel of a mobility vehicle, the steering and suspension system comprising:
a bevel gear connecting the wheel and a vehicle body and configured to axially rotate about a rotation axis thereof and to turn when the mobility vehicle turns; and
a gear rotation guide engaged with the bevel gear and configured to guide a moving path of the bevel gear as the bevel gear moves while axially rotating.

14. The steering and suspension system of claim 13, further comprising a rubber torsion suspension configured to alleviate shock transferred from a road surface to the vehicle body through the wheel, wherein the bevel gear is disposed to be spaced apart from the rubber torsion suspension in a height direction of the mobility vehicle.

15. The steering and suspension system of claim 14, wherein:
the rubber torsion suspension is located further toward a center of the vehicle body than an axis of the wheel in a length direction of the mobility vehicle; and
the bevel gear is disposed above a top surface of the rubber torsion suspension and the rotation axis of the bevel gear is on the same axis as the axis of the wheel.

16. The steering and suspension system of claim 15, wherein the wheel is steered by driving a steering motor directly connected to the bevel gear.

17. The steering and suspension system of claim 13, wherein the gear rotation guide has a convex shape curving toward an inner side of the vehicle body.
